(19) United States
(12) Patent Application Publication
(10) Pub. No.: US 2025/0048973 A1
(43) Pub. Date: Feb. 13, 2025

(54) Straw Chopper for a Combine Harvester

(71) Applicant: AGCO do Brasil Soluções Agrícolas Ltda., Ribeirao Preto (BR)

(72) Inventor: Marcelo Carpenedo, Sapucaia do Sul (BR)

(21) Appl. No.: 18/770,460

(22) Filed: Jul. 11, 2024

(30) Foreign Application Priority Data
Aug. 11, 2023 (GB) 2312339.1

(51) Int. Cl. A01F 29/04; A01D 41/12

(52) U.S. Cl. CPC A01F 29/04; A01D 41/1243

(57) ABSTRACT

A straw chopper for a combine harvester has blades extending outwardly from a central hub which rotates about a rotation axis. A feeding channel is formed along the full length of the chopper with an inlet and an outlet angularly offset around the rotation axis by less than 180 degrees. Inwardly facing guide vanes are provided on an outer drum around the blades and the guide vanes are angled so that they are non-perpendicular to the length direction. The vanes thus induce a small lateral movement of the straw so that cuts can be provided at multiple straw positions.

### FIELD

Embodiments of the present disclosure relate generally to combine harvesters, and in particular to a straw chopper spreader used within a combine harvester.

### BACKGROUND

A combine harvester typically includes a threshing system for detaching grains of cereal from material other than grain, such as cobs, stems and seed pods, a separating apparatus downstream of the threshing system, and a grain cleaning apparatus (known as the cleaning shoe) for receiving grain from the separating apparatus. A stratification pan aims to stratify the material into a layered structure of grain at the bottom and light chaff and other material other than grain (MOG) at the top. The grain is collected in a grain bin, and from the grain bin the grain can be unloaded, for example to a trailer pulled by a tractor which runs alongside the combine harvester.

It is well known to install chaff spreaders for collecting and distributing MOG (i.e., chaff) ejected from the rear of the cleaning shoe. A chaff spreader for example comprises a pair of fan modules which eject the chaff at a tangent to a fan rotation axis.

It is also well known to install a straw chopper behind the threshing and separating apparatus for cutting straw, and to use a straw spreader to distribute the cut straw over the field. The straw chopper for example comprises a set of rotating blades which extend radially outwardly from a central hub, within a chopper drum. The chopper extends across the width of the combine, and rows of multiple blades are pivotally fixed around the circumference of the central hub.

The straw spreader typically comprises rotary spinners (impellers) which drive the material into an output channel with a desired outlet direction. For example, a typical straw spreader has a pair of spinners, to actively accelerate the chopped straw and spread it at the back of the combine.

It is also known to enable the chaff from the chaff spreader to be fed into the straw chopper and/or straw spreader. For example, in a first mode, the chaff may be delivered to the straw chopper so that the chaff is spread together with the chopped straw, across the full cutting width. The straw spreading system provides a better distribution over the harvested field than a typical chaff spreader. In a second mode, a straw swath is formed, and the chaff spreader can be slowed down to mix the chaff with the straw swath to maximize the quantity and quality of straw. In a third mode, the chaff is spread before entering the straw chopper or spreader, by directing the chaff to the sides using deflectors.

One main challenge is to improve the straw quality in terms of how well it is chopped, namely the target chopping length and the percentage of the material that is correctly cut to that target length.

There are many known design features which aim to improve the chopping consistency and reduce the chopping length. One example is the so-called “Material Brake”. The material brake is a step feature applied on the chopper floor which disturbs the material flow around the chopper drum, forcing the straw to stop or reduce its motion when hitting the feature, allowing that the chopper blades to pass through that specific portion of straw and cut the material an increased number of times. The material brake is designed to be movable, enabling it to be engaged or not engaged on the chopper floor, according to the customer needs. Another example is the use of a so-called “Counter Knives Group”. This is a set of stationary knives mounted to the drum placed along the chopper drum floor. They function to force the material to pass through a scissor type arrangement, to further decrease the size of the material being chopped.

There are also other known features such as a serrated bar, normally commonly applied together the counter knives group, generating an effect similar, but reduced, to the counter knives group.

These known features improve the material cutting process inside the chopper essentially by forcing the straw to have more contact with the chopper knives. However, the flow through the chopper is a tangential flow which means that the additional contact with the chopper knives is always with the same chopper knives, i.e., at the same lateral position along the chopper. The knives for example pass 2 or 3 times faster through the straw relative to the straw traveling speed. As a result, the additional cutting steps will often simply pass through an existing cut that has already been made, rather than cutting the straw into shorter portions.

It would be desirable to enable additional cutting steps to be provided which more often make new cuts through the straw and hence result in a shorter chopping length and more uniform distribution of chopping lengths.

WO 2018/162974 discloses a straw chopper in which straw is fed only to a central region of the chopper drum. Three outlets are defined; one at a central area of the chopper drum and two laterally offset outlets. Material follows a helical path to reach the laterally offset outlets, and guide vanes are used to direct the material along this helical path.

### BRIEF SUMMARY

The invention is defined by the claims.

According to examples in accordance with the invention, there is provided a straw chopper for a combine harvester, comprising:
an outer drum portion;
a central hub within the outer drum portion, the central hub having a length, and a rotation axis along the length direction; and
a set of blades extending outwardly from the central hub, wherein a feeding channel is defined between the outermost ends of the blades and the outer drum portion, wherein the feeding channel comprises an inlet along substantially the full length of an inlet end of the outer drum portion and an outlet along the substantially the full length of an outlet end of the outer drum portion, the inlet and outlet being angularly offset around the rotation axis by less than 180 degrees,
wherein the outer drum portion comprises inwardly facing guide vanes, wherein the guide vanes comprise a first set to one lateral side of the outer drum portion and a second set to the other lateral side of the outer drum portion, each of the first set of vanes having a single common first non-perpendicular angle to the length direction and each of the second set of vanes having a second single common non-perpendicular angle to the length direction.

The invention is based on the recognition that material flowing through a conventional straw chopper does not change position transversally to the chopper (i.e., along the chopper rotation axis) so that providing multiple cutting actions may not be very effective, in that they simply follow already cut paths through the straw.

The invention aims to increase the severity of the straw chopper operation over the material being processed and consequently increase the material quality by making it finer.

The invention provides a simple solution which provides a lateral movement of the straw but without requiring a helical path to be followed. The design of the invention does not require any additional length (along the rotation axis direction) of the chopper and thus enables straw to be fed to the full width of the chopper and to be delivered by the full width of the chopper. By avoiding the need for recirculation, the mass flow capability of the chopper is also not adversely affected.

The design provides lateral movement of the straw but only by a limited amount simply to introduce an offset so that the paths of the rotating blades meet different locations along the body of straw. This is thus enough to increase the straw chopping quality. Only a modest increase in power consumption is needed to implement the limited additional lateral straw movement. The invention thus provides a modification to the floor of the outer drum as a very simple way to increase the straw chopping quality.

The guide vanes extend along a fraction of the circumferential extent of the outer drum portion over an angle between of between 10 and 90 degrees, preferably between 20 and 70 degrees, more preferably around 45 degrees.

The set of blades preferably comprises multiple blades along the length of the central hub and multiple blades around the central hub. There are for example four blades at different angular positions around the hub, and multiple sets of such four blades along the length of the chopper. Adjacent sets may be offset angularly with respect to each other.

The straw chopper may further comprise static blades attached to the outer hub portion. These function as a counter knives group, as discussed above.

The guide vanes are for example angled from the perpendicular by an angle in the range 5 to 25 degrees. Thus, they provide a shallow lateral redirection of the straw flow so that the blades are able to make new cuts to the straw.

The guide vanes are for example angled from the perpendicular by an angle in the range 10 to 20 degrees.

The first set of guide vanes to one lateral side of the outer drum portion steer straw towards the center and the second set of guide vanes to the other lateral side of the outer drum portion steer straw towards the center. Thus, the guide vanes steer the straw symmetrically towards the center from the lateral outer edges. The vanes in this way do not alter the symmetry of the output distribution. The guide vanes may instead guide material from the center outwardly, or even in one lateral direction only/

The guide vanes can for example be selectively engaged and disengaged. In this way, a user can choose the characteristics of the chopped straw. The engagement and disengagement may be manual or automated.

The guide vanes may also be removable from the remainder of the outer drum portion. This simplifies cleaning and replacement and also enables different blade designs to be used.

The straw chopper for example has a feed panel leading to the inlet end of the outer drum portion and a delivery panel leading from the outlet end of the outer drum portion. The chopping function thus primarily takes place over the angular extent of the outer drum portion.

The outer drum portion for example extends around the rotation axis by an angle between 30 and 120 degrees.

The invention also provides a combine harvester comprising:
a crop cutting head;
a threshing and separating system;
the straw chopper as defined above for cutting MOG received from the threshing and separating system; and
a straw spreader receiving a straw flow from the straw chopper and distributing the straw.

In another aspect, the invention provides a straw chopper for a combine harvester, comprising:
an outer drum portion;
a central hub within the outer drum portion, the central hub having a length, and a rotation axis along the length direction; and
a set of blades extending outwardly from the central hub,
wherein the outer drum portion comprises inwardly facing guide vanes for guiding the flow of straw through the straw chopper, wherein the guide vanes are removable or adjustable retractable so that the straw chopper has at least two different operating modes with different straw chopping characteristics.

The vanes are used to change the chopping characteristics, for example by inducing a movement of straw so that additional cuts are made by the blades. A user can thus choose the operating mode, and hence chopped straw characteristics, by selecting whether to use the vanes or not. The chopped straw characteristics may be selected depending on crop conditions and desired fuel consumption for example. The guide vanes may be retracted between operating and non-operating positions, or they may be removed altogether, or their orientations may be adjustable. Any combination of these adaptations is also possible.

The guide vanes are for example for guiding a movement of straw along the length direction of the central hub.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 shows a combine harvester which may be adapted in accordance with the invention;

FIG. 2 shows one example of threshing system and grain cleaning apparatus in more detail;

FIG. 3 shows a first example of a known straw chopper and also shows a first known design feature in the form of a so-called material brake;

FIG. 4 shows another feature in the form of a so-called counter knives group;

FIG. 5 shows an additional feature (compared to FIG. 4) of a serrated bar;

FIG. 6 shows an example in accordance with the invention;

FIG. 7 shows an enlarged view of a portion of FIG. 6;

FIG. 8 shows a view of the whole chopper;

FIG. 9 shows the lateral shift in straw which takes place as the straw is driven around the chopper; and

FIG. 10 shows the arrangement of FIGS. 6 and 7 in end view.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure provides a straw chopper for a combine harvester that comprises blades extending outwardly from a central hub which rotates about a rotation axis. A feeding channel is formed along the full length of the chopper with an inlet and an outlet angularly offset around the rotation axis by less than 180 degrees. Inwardly facing guide vanes are provided on an outer drum around the blades and the guide vanes are angled so that they are non-perpendicular to the length direction. The vanes thus induce a (small) lateral movement of the straw so that cuts can be provided at multiple straw positions.

This disclosure relates to the design of a straw chopper for use with a combine harvester. However, a general outline of a combine harvester will first be provided.

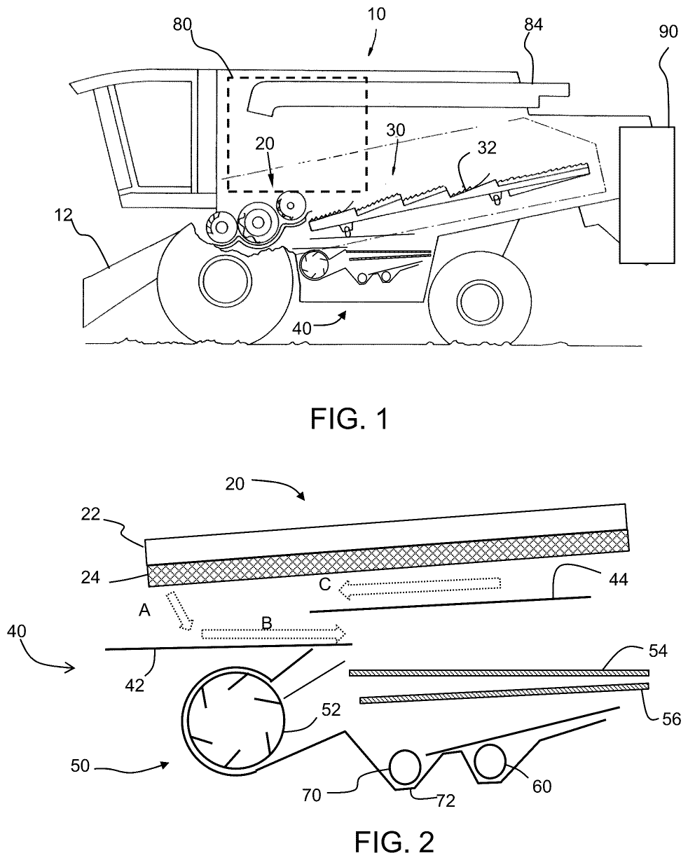

FIG. 1 shows a known combine harvester 10 to which the invention may be applied. The combine harvester includes a threshing system 20 for detaching grains of cereal from the ears of cereal, and a separating apparatus 30 which is connected downstream of the threshing system 20. The threshing system comprises one or more threshing units, in particular rotors, and associated concaves. In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The grain cleaned by the grain cleaning apparatus is delivered to a grain bin 80 by a filling auger 70. Grain from the grain bin is removed from the combine harvester by an unloading tube 84.

The combine harvester has a front elevator housing 12 at the front of the machine for attachment of a crop cutting head (known as the header, not shown). The header when attached serves to cut and collect the crop material as it progresses across the field, the collected crop stream being conveyed up through the elevator housing 12 into the threshing system 20.

In the example shown, the threshing system 20 is a tangential-flow ‘conventional’ threshing system, i.e., formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e., formed by rotating elements with an axis of rotation in the longitudinal direction (direction of travel). For example, the threshing section may have axially-aligned rasp bars spaced around the front section whilst the separating section has separating elements or fingers arranged in a pattern, e.g., a spiral pattern, extending from the rasp bars to the rear of the rotor.

The MOG (material other than grain), in particular chaff, exits the combine harvester at the back. This invention relates to a straw chopper provided at the back of the combine harvester. The straw chopper is used in combination with a straw spreader, and they are together represented as unit 90 in FIG. 1.

As mentioned above, instead of tangential flow threshing (and separating), axial threshing (and separating) is also known, and the invention may be applied to any type of combine. For completeness, FIG. 2 shows an axial threshing and separating system 20, together with a more detailed view of the cleaning apparatus 40.

The threshing system 20 in this case comprises an axial rotor 22 beneath which is mounted the concave 24. The concave may have different sections along its length, and the first section to receive the crop material (to the left in FIG. 2) may have a releasable concave, or else the whole length of the concave may be releasable. The separating function for this type of combine involves conveying the crop stream rearwardly in a ribbon passing along a spiral path.

No matter what type of threshing is performed, the initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 does not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 removes this unwanted material thus leaving a clean sample of grain to be delivered to the bin.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the more dense grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to the on-board bin by the filling auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner. The grain is for example smaller and denser and generally more aerodynamic than MOG, therefore, less susceptible to being conveyed rearward by the chaffer/sieve and/or blown out of the rear of the machine by the air stream of the cleaning fan, passing upward and rearward, through the chaffer.

All material which has not been collected by the filling auger 70 or returns auger exits the back of the combine harvester and passes to a chaff spreader. The chaff spreader receives the rejected material from the cleaning shoe.

As explained above, it is known to provide a straw chopper and straw spreader for the straw output by the separating apparatus, such as the straw walker and this disclosure relates in particular to the design of the straw chopper.

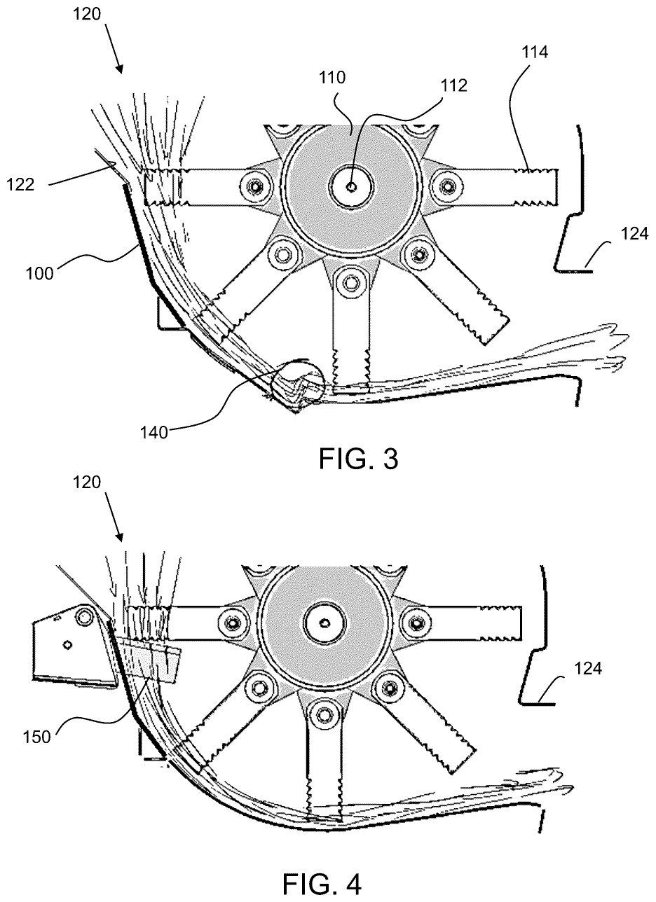

FIG. 3 shows a first example of a known straw chopper, comprising an outer drum 100 and a central hub 110 within the outer drum. The central hub has a length along a rotation axis 112. Blades 114 extend outwardly from the central hub, with serrated ends. The blades are pivotally attached to the central hub 110. In this example, there are four blades disposed at 90 degree intervals (forming a set) around the central hub. Adjacent sets are offset by 45 degrees, so that eight blades can be seen in end view.

A feeding channel 120 is defined between the outermost ends of the blades 114 and the outer drum 100. The feeding channel has an inlet 122 which extends along substantially the full length of an inlet opening of the outer drum and the feeding channel has an outlet 124 also along substantially the full length of the outer drum. The inlet and outlet are angularly offset around the rotation axis 112 by less than 180 degrees for example around 100 degrees. A small portion of drum wall is adjacent the outlet 124, to define the outlet channel shape and thereby limit the area where the straw is discharged. The drum is otherwise open at the top.

The blades rotate faster than the flow of crop material, i.e., the radially outermost ends of the blades have a linear speed which is greater than the linear flow speed of the straw flow.

FIG. 3 shows a first known additional design feature in the form of the so-called material brake 140 mentioned above. It is a step applied to the floor of the outer drum which disturbs the material flow around the drum, forcing the straw to stop or reduce its motion when hitting the step so that the chopper blades cut the material an increased number of times. The material brake is for example designed to be movable, enabling it to be engaged or not engaged on the chopper floor, according to the customer needs.

FIG. 4 shows another feature in the form of a so-called counter knives group 150. It comprises stationary blades mounted to the drum and interleaved with the rotating blades. It holds back the straw so that the rotating knives cut the held back straw. The knives of the counter knives group function to force the material to pass through a scissor type arrangement, to further decrease the size of the material being chopped.

Each rotating blade may comprise a spaced pair of blade elements, and they pass each side of an associated knife of the counter knives group 150.

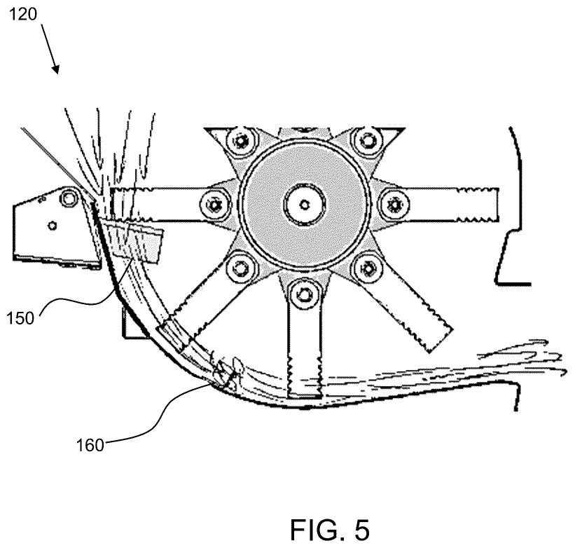

FIG. 5 shows an additional feature (compared to FIG. 4) of a serrated bar 160 formed at the bottom wall of the outer drum.

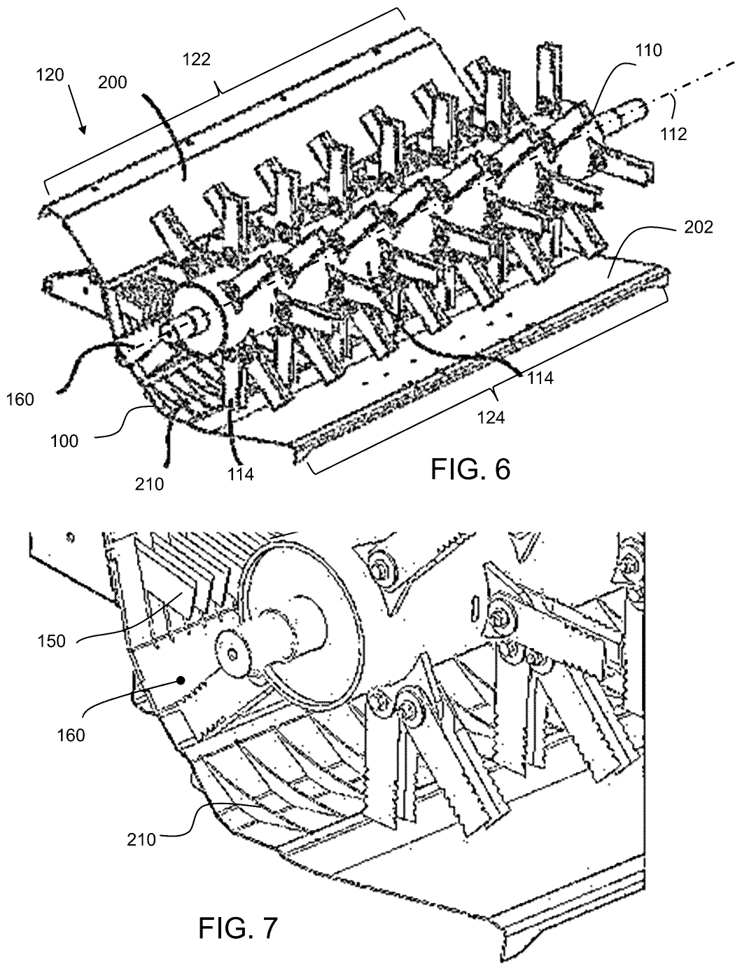

FIG. 6 shows an example in accordance with the invention.

The straw chopper again has an outer drum 100. The outer drum only extends around a portion of the central hub 110 and blades 114, and hence it is described below as an “outer drum portion”. There is also a wall portion defining the outlet, as explained above. Material coming from the processor is thrown and directed over the top drum area. The material is guided by the rotation of the blades through the gap between the central hub 110 and the outer drum. This gap defines the feeding channel 120 as mentioned above. The feeding channel 120 extends between an inlet 122 and outlet 124.

Although all material is enabled to fall over the entire top drum area, the flow characteristics of the incoming material flow mean that the material is almost in its totality delivered close to the area of the inlet 122, so that nearly all of the material is guided along the feeding channel.

FIG. 6 shows the central hub 110 with its rotation axis 112, the rotation axis 112 lying along the central axis of a cylinder which defines the shape of the outer drum portion. The blades 114 are shown as sets of four blades around the central hub. Each set is offset by 45 degrees relative to the adjacent set.

The inlet 122 to the deeding channel 120 again extends along substantially the full length of an inlet end of the outer drum portion and the outlet 124 extends along substantially the full length of an outlet end of the outer drum portion. The inlet 122 and outlet 124 are angularly offset around the rotation axis by around 100 degrees in this example, but generally less than 180 degrees, for example between 30 degrees and 120 degrees. A feed panel 200 leads to the inlet and a delivery panel 202 leads from the outlet.

The outer drum portion 100 comprises inwardly facing guide vanes 210. The guide vanes 210 are angled so that they are non-perpendicular to the length direction. In other words, they slant across the chopper length direction, so that their direction has a component along the direction of the rotation axis, i.e., along the chopper length direction (which is the lateral width direction of the combine).

The guide vanes 210 in this example are only provided on a section of the outer drum portion between the inlet 122 and the outlet 124. Thus, the guide vanes 210 are only along a fraction of the circumferential extent of the outer drum portion 100. For example, the guide vanes 210 may extend over an angle (about the rotation axis) of between 10 and 90 degrees, for example between 20 and 70 degrees, for example around 45 degrees. Thus, the guide vanes 210 are discrete individual elements, parallel to each other, and in a row along the length of the chopper. The guide vanes 210 may instead extend around the entire circumferential length of the outer drum portion.

The guide vanes 210 cause the straw to shift laterally along the rotation axis direction, and hence move from the path of the sets of blades so that the blades (in particular blades of the same set along the chopper), make new cuts in the straw. However, to make an increase in the severity of chopping, the lateral shift only needs to be at most the distance of the spacing between the sets of blades, i.e., less than the axial spacing between adjacent sets of blades. This small amount of lateral straw movement increases the severity of the straw chopper operation over the material being processed and consequently increases the material quality by making it finer. Thus, the total lateral movement imparted by the guide vanes 210 is less than the spacing between sets of blades. The flow of straw is only intended to undergo one lateral shift in its flow path from the inlet 122 to the outlet 124.

The invention provides a simple solution which only needs a small shift in material mass, and does not require a helical path to be followed. The chopper does not need any increase in length and straw is fed to the full length of the chopper. Only a modest increase in power consumption is needed to implement the additional lateral straw movement. The invention thus provides a modification to the floor of the outer drum as a very simple way to increase the straw chopping quality.

The concept of the invention may be combined with other features. For example, the straw chopper may further comprise the counter knives group 150 explained above, as well as the serrated bar 160.

FIG. 7 shows an enlarged view of a portion of FIG. 6 and shows the guide vanes 210 more clearly, as well as the counter knives group 150 and the serrated bar 160. Each blade comprises a parallel pair of blade elements, and they pass each side of an associated knife of the counter knives group 150. The guide vanes are for example angled relative to a circle defined by the cylindrical drum by an angle in the range 5 to 25 degrees, for example 10 to 20 degrees, such as 15 degrees. Thus, they provide a shallow lateral redirection of the straw flow so that the blades are able to make new cuts to the straw.

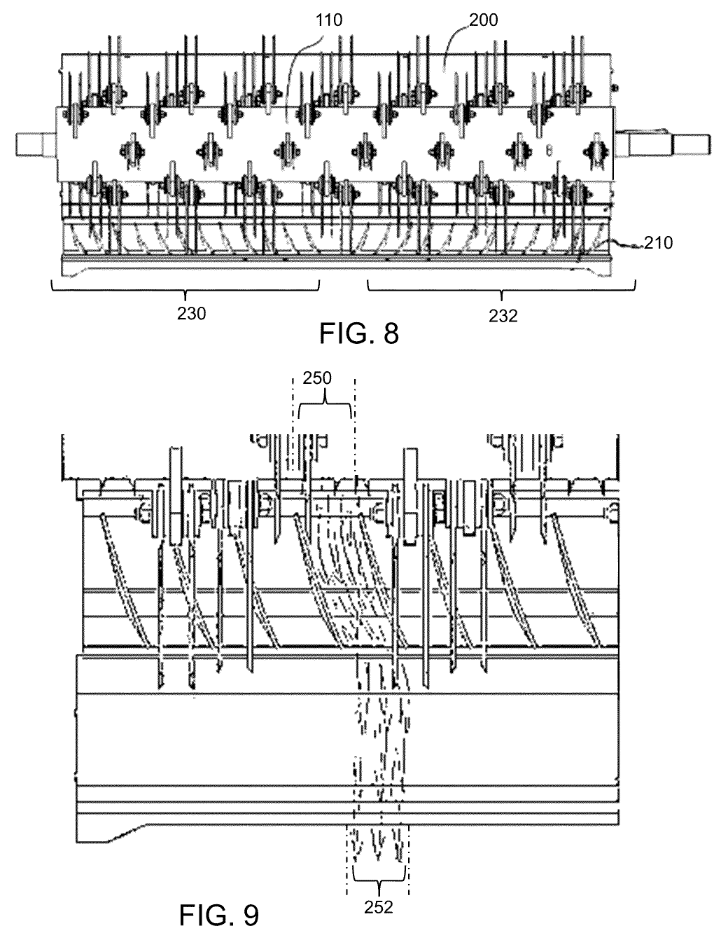

FIG. 8 shows a view of the whole chopper. It shows that in this particular example the guide vanes comprise a first set 230 to one lateral side of the outer drum portion for steering straw towards the center and a second set 232 to the other lateral side of the outer drum portion for steering straw towards the center. Each of the first set 230 of vanes having a single common first non-perpendicular angle to the length direction and each of the second set 232 of vanes having a second single common non-perpendicular angle to the length direction. The first non-perpendicular angle and the second non-perpendicular angle are equal in degree. Thus, the guide vanes 210 steer the straw symmetrically towards the center from the lateral outer edges. The guide vanes 210 in this way do not alter the symmetry of the output distribution. The guide vanes 210 may instead guide material in a lateral outward direction from the center. Alternatively, the guide vanes 210 may all slope in the same way and simply all impart a lateral shift in the same direction.

FIG. 9 shows the lateral shift in straw which takes place as the straw is driven around the inner surface of the outer drum portion. A body of straw is positioned within the lateral positional range shown as 250 before it encounters the guide vanes 210, and is shifted laterally to the lateral position range shown as 252 after it has encountered the guide vanes 210. With all the straw moved laterally to a new position, each blade 114 makes a cut to a new location with respect to the position of the body of straw.

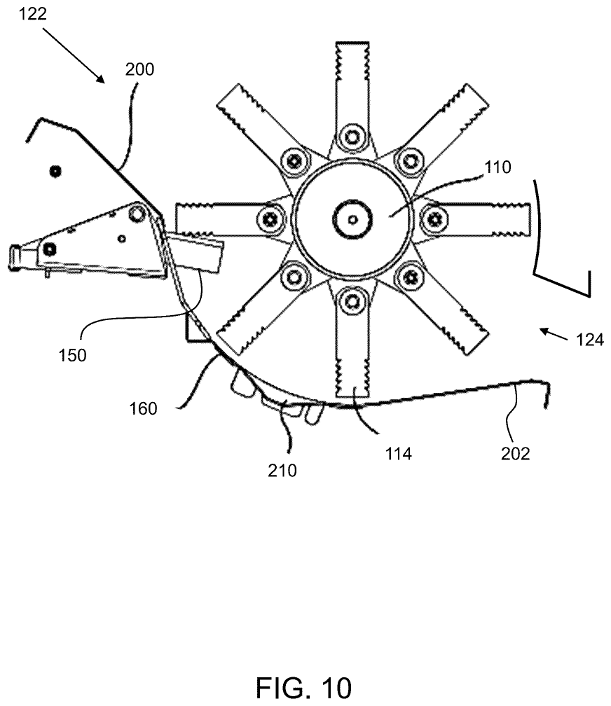

FIG. 10 shows the arrangement of FIGS. 6 and 7 in end view.

The guide vanes 210 can for example be selectively engaged and disengaged. In this way, a user can choose the characteristics of the chopped straw. The engagement may be manual or automated.

The guide vanes 210 may also be removable from the remainder of the outer drum portion. This simplifies cleaning and replacement and also enables different blade designs to be used. They may instead be retractable so that they can be actuated into a non-operative position rather than removed. They may instead be adjustable in other ways, for example their orientation may be adjustable.

This adjustment, retraction or removal of the guide vanes 210 may be applied to other vane designs, not only the vane designs described above. Thus, this concept may be applied more generally to inwardly facing guide vanes for guiding the flow of straw through the straw chopper. The adaptation of the vanes results in different straw chopping characteristics.

The invention may be applied to any design of combine harvester. Thus, it does not rely on any particular threshing, separating or cleaning design, and the examples above are only given to aid overall understanding.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

What is claimed is:

1. A straw chopper for a combine harvester, comprising:
an outer drum portion;
a central hub within the outer drum portion, the central hub having a length, and a rotation axis along the length direction; and
a set of blades extending outwardly from the central hub, wherein a feeding channel is defined between the outermost ends of the blades and the outer drum portion, wherein the feeding channel comprises an inlet along substantially the full length of an inlet end of the outer drum portion and an outlet along the substantially the full length of an outlet end of the outer drum portion, the inlet and outlet being angularly offset around the rotation axis by less than 180 degrees,
wherein the outer drum portion comprises inwardly facing guide vanes, wherein the guide vanes comprise a first set to one lateral side of the outer drum portion and a second set to the other lateral side of the outer drum portion, each of the first set of vanes having a single common first non-perpendicular angle to the length direction and each of the second set of vanes having a second single common non-perpendicular angle to the length direction.

2. The straw chopper of claim 1, wherein the guide vanes extend along a fraction of the circumferential extent of the outer drum portion over an angle of between 10 and 90 degrees.

3. The straw chopper of claim 2, wherein the guide vanes extend along a fraction of the circumferential extent of the outer drum portion over an angle between 20 and 70 degrees.

4. The straw chopper of claim 3, wherein the guide vanes extend along a fraction of the circumferential extent of the outer drum portion over an angle of around 45 degrees.

5. The straw chopper of claim 1, wherein the set of blades comprises multiple blades along the length of the central hub and multiple blades around the central hub.

6. The straw chopper of claim 1, further comprising static blades attached to the outer hub portion.

7. The straw chopper of claim 1, wherein the guide vanes are angled from the perpendicular by an angle in the range 5 to 25 degrees.

8. The straw chopper of claim 7, wherein the guide vanes are angled from the perpendicular by an angle in the range 10 to 20 degrees.

9. The straw chopper of claim 1, wherein the first set of guide vanes to one lateral side of the outer drum portion steer straw towards the center and the second set of guide vanes to the other lateral side of the outer drum portion steer straw towards the center.

10. The straw chopper of claim 1, wherein the guide vanes can be selectively engaged and disengaged.

11. The straw chopper of claim 1, wherein the guide vanes are removable from the remainder of the outer drum portion.

12. The straw chopper of claim 1 comprising a feed panel (200) leading to the inlet end of the outer drum portion and a delivery panel (202) leading from the outlet end of the outer drum portion.

13. The straw chopper of claim 1, wherein the outer drum portion extends around the rotation axis by an angle between 30 and 120 degrees.

14. A combine harvester comprising:
a crop cutting head;
a threshing and separating system;
the straw chopper of claim 1 for cutting MOG received from the threshing and separating system; and
a straw spreader receiving a straw flow from the straw chopper and distributing the straw.

15. A straw chopper for a combine harvester, comprising:
an outer drum portion;
a central hub within the outer drum portion, the central hub having a length, and a rotation axis along the length direction; and
a set of blades extending outwardly from the central hub,
wherein the outer drum portion comprises inwardly facing guide vanes for guiding the flow of straw through the straw chopper, wherein the guide vanes are removable or retractable or adjustable so that the straw chopper has at least two different operating modes with different straw chopping characteristics.

16. The straw chopper of claim 15, wherein the guide vanes are for guiding a movement of straw along the length direction of the central hub.
